(19) United States
(12) Patent Application Publication
(10) Pub. No.: US 2025/0249927 A1
(43) Pub. Date: Aug. 7, 2025

(54) HYBRID AUTOMATED DRIVING ARCHITECTURE

(71) Applicant: QUALCOMM Incorporated, San Diego, CA (US)

(72) Inventors: Meysam Sadeghigooghari, Linköping (SE); Ahmed Kamel Sadek, San Diego, CA (US); Jacob Roll, Linköping (SE); Per Cronvall, Linköping (SE); Avdhut Joshi, San Marcos, CA (US); Per Albert Siden, Linköping (SE); Thomas Svantesson, Linköping (SE); Gustav Nils Ture Persson, Ljungsbro (SE)

(21) Appl. No.: 19/018,813

(22) Filed: Jan. 13, 2025

Related U.S. Application Data
(60) Provisional application No. 63/553,064, filed on Feb. 13, 2024.
(60) Provisional application No. 63/549,916, filed on Feb. 5, 2024.

(51) Int. Cl. B60W 60/00; B60W 50/00; B60W 50/06

(52) U.S. Cl. CPC B60W 60/001; B60W 50/0097; B60W 50/06

(57) ABSTRACT

An apparatus comprises one or more memories, and one or more processors in communication with the one or more memories. The one or processors are configured to execute an automated driving system having a modular hybrid architecture. The modular hybrid architecture includes a plurality of task units, and the modular hybrid architecture includes one or more human-defined interfaces, and one or more AI-defined interfaces. The one or more processors are further configured to receive input data from one or more sensors process the input data using the automated driving system having the modular hybrid architecture, and control at least one operation of a vehicle according to an output of the automated driving system.

This application claims the benefit of U.S. Provisional Application No. 63/549,916, filed Feb. 5, 2024, and U.S. Provisional Application No. 63/553,064, filed Feb. 13, 2024, the entire content of each of which is incorporated by reference herein.

### TECHNICAL FIELD

This disclosure relates to advanced driver assistance systems and autonomous driving.

### BACKGROUND

Autonomous vehicles and semi-autonomous vehicles may include an advanced driver assistance system (ADAS) using sensors and software to help operate the vehicles. An ADAS may use artificial intelligence (AI) and machine learning (ML) (e.g., deep neural network (DNN)) techniques for performing various operations for operating, piloting, and navigating the vehicles. For example, ML models may be used for object detection, lane and road boundary detection, safety analysis, drivable free-space analysis, control generation during vehicle maneuvers, and/or other operations. ML model-powered autonomous and semi-autonomous vehicles should be able to respond properly to a diverse set of situations, including interactions with emergency vehicles, pedestrians, animals, and a number of other obstacles.

### SUMMARY

This disclosure describes a modular hybrid automated driving architecture for use in autonomous and semi-autonomous vehicles. In one example, the modular hybrid automated driving architecture described herein may be part of an ADAS. In examples of the disclosure, a modular hybrid driving architecture may include a plurality of modules and/or processing units that may be configured for a specific function or tasks (e.g., task units). Each of the plurality of modules and/or processing units may include multiple sub-units and/or sub-modules. In accordance with the techniques of this disclosure, the modular hybrid architecture may include both one or more human-defined interfaces, and one or more AI-defined interfaces.

In one example, this disclosure describes an apparatus comprising one or more memories, and one or more processors in communication with the one or more memories. The one or processors are configured to execute an automated driving system having a modular hybrid architecture, wherein the modular hybrid architecture includes a plurality of task units, and wherein the modular hybrid architecture includes one or more human-defined interfaces, and one or more AI-defined interfaces. The one or more processors are further configured to receive input data from one or more sensors, process the input data using the automated driving system having the modular hybrid architecture, and control at least one operation of a vehicle according to an output of the automated driving system.

In another example, this disclosure describes a method comprising executing an automated driving system having a modular hybrid architecture, wherein the modular hybrid architecture includes a plurality of task units, and wherein the modular hybrid architecture includes one or more human-defined interfaces, and one or more AI-defined interfaces, and wherein executing the automated driving system having the modular hybrid comprises receiving input data from one or more sensors, processing the input data using the automated driving system having the modular hybrid architecture, and controlling at least one operation of a vehicle according to an output of the automated driving system.

In another example, this disclosure describes an apparatus comprising means for performing any combination of techniques of this disclosure.

In another example, this disclosure describes a non-transitory computer-readable storage medium storing instructions that, when executed, cause one or more processors to perform any combination of techniques of this disclosure.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle that may incorporate a hybrid automated driving architecture in accordance with the techniques of this disclosure.

FIG. 2 is a block diagram illustrating an example computing system that may incorporate a hybrid automated driving architecture in accordance with the techniques of this disclosure.

FIG. 3 is a block diagram illustrating an example modular automated driving architecture in accordance with the techniques of this disclosure.

FIG. 4 is a block diagram illustrating an example full end-to-end automated driving architecture in accordance with the techniques of this disclosure.

FIG. 5 is a block diagram illustrating an example hybrid automated driving architecture in accordance with the techniques of this disclosure.

FIG. 6 is a block diagram illustrating an example modular hybrid partial end-to-end automated driving architecture in accordance with the techniques of this disclosure.

FIG. 7 is a block diagram illustrating an example architecture for a perception unit of FIG. 6 in more detail.

FIG. 8 is a block diagram illustrating an example architecture for a second environment model unit of FIG. 6 in more detail.

FIG. 9 is a block diagram illustrating an example architecture for an AI planning unit of FIG. 6 in more detail.

FIG. 10 is a block diagram illustrating an example architecture for a rule-based planning unit of FIG. 6 in more detail.

FIG. 11 is a block diagram illustrating an example modular hybrid full end-to-end automated driving architecture in accordance with the techniques of this disclosure.

FIG. 12 is a block diagram illustrating an example architecture for a perception unit of FIG. 11 in more detail.

FIG. 13 is a block diagram illustrating an example architecture for a second environment model unit of FIG. 11 in more detail.

FIG. 14 is a block diagram illustrating another example architecture for a perception unit and a second environment model unit of FIG. 11 in more detail.

FIG. 15 is a block diagram illustrating an example architecture for an AI planning unit of FIG. 11 in more detail.

FIG. 16 is a flow diagram illustrating an example method in accordance with the techniques of this disclosure.

FIG. 17 is a conceptual diagram illustrating an example of adding an AI-defined interface to neural networks with a human-defined interface.

FIG. 18 is a conceptual diagram illustrating an example of adding a human-defined interface to neural networks with an AI-defined interface.

### DETAILED DESCRIPTION

Autonomous driving (AD) systems, such as an ADAS, are conventionally designed in a modular way, where the autonomous driving system is divided into modules and a module consumes the output(s) of previous module(s) and provides the input(s) for the next module(s). In autonomous driving, different modules are configured to perform different tasks. Such tasks may include object detection, object tracking through time, environmental modeling, prediction, planning, control, and others. Some of the modules may be configured to perform a particular task by implementing a neural network or other machine learning architecture.

Each module or processing task (e.g., task unit) in a modular architecture provides a certain output that is passed to the next module. The outputs of such modules may be well-defined human interfaces. In the context of this disclosure, a human-defined interface is defined based on human intentions (e.g., prior knowledge and experience, system requirements, safety metrics, etc.) and has real world interpretations (e.g., a bounding box around a vehicle, the object class of lane marking, etc.). Hence, data output according to a human-defined interface can provide inductive biases and simplify the training of the system. The interpretability of the output of the human-defined interface allows use for a variety of purposes (e.g., visualization, debugging, safety functions).

In some examples, human-defined interfaces may include output formats that are either undersubscribed or oversubscribed. An undersubscribed output format may include too little information for proper training and update, while an oversubscribed output format may have more information than is needed.

Another approach to design an automated driving system is a fully end-to-end (E2E) approach, where the systems use a neural network that receives input from one or more sensors and generates the final output without any intermediate module. Fully E2E architectures use AI-defined interfaces. An AI-defined interface may be a tensor of numerical values (e.g., features) that are obtained by an optimization algorithm (e.g., back propagation) to achieve a certain set of objectives. Hence, an AI-defined interface is implicitly defined by the needs of downstream tasks. This allows the AI-defined interface to be more versatile and comprehensive than a human-defined interface, while possibly not having explicit human interpretations. In general, AI-defined interfaces are implicitly defined by an optimization process, whereas human-defined interfaces are explicitly defined by a human. In the case of a neural network, a loss function would be used to make the network adhere to this definition of the human-defined interface.

Conventional non-E2E system designs, such as a modular architecture, are unable to optimize the full stack of processing task (e.g., consider all modules at once) and are unable to align different modules and their sometimes contradictory objectives. Typically, processing task or module of a non E2E architecture is locally optimized, ignoring any subsequent or end task(s). Each processing task or module of the non E2E architecture is optimized/evaluated against metrics that might be irrelevant or not with regard to the end goal of the system. For example, the recall or precision of an object detection module may not be the best metric to be optimized for the final planning and control module. As such, some non-E2E systems may exhibit deficient task coordination, may lose accuracy due to a growing compounding error, and may have a higher total compute cost.

Additionally, some modules of a non-E2E system are adjusted manually (e.g., based on experts guess work), which is often not data driven. Hence, updating and training a non-E2E system may be time consuming and costly. Furthermore, the planning or control module, responsible for generating steering and acceleration outputs, plays an important role in determining the driving experience. The most common approach for planning in modular pipelines, such as a modular architecture, involves using sophisticated rule-based designs, which are often ineffective in addressing the vast number of situations that occur while driving.

Fully E2E systems also exhibit drawbacks. Fully E2E systems are typically more complex compared to non-E2E designs. Also, the safety and interpretability of an E2E system become more challenging due to lack of human interpretable interfaces. As such, troubleshooting is more involved due to lack of human interpretable interfaces. Adding and/or introducing new human-defined inputs/interfaces is often not trivial. Furthermore, branching and system extension is more complex in E2E systems due to the lack of well-defined interfaces.

In view of these drawbacks, this disclosure describes a hybrid modular E2E architecture. Rather than only using human-defined interfaces or only using AI-defined interfaces (e.g., neural network features), a hybrid modular E2E automated driving architecture of this disclosure uses a combination of both human-defined interface and AI-defined interfaces, both between processing tasks, and between sub-units of a single processing task.

In general, an AI-defined interface outputs neural network features (e.g., feature tensors) that may be directly consumed by a subsequent neural network. The representation of features passed through the AI-defined interface is optimized as part of the neural network training to ensure flow of the information most relevant to the downstream tasks. Examples of modular hybrid architecture of this disclosure contain both end-to-end aspects, as well human-defined interfaces due to their modular design and auxiliary losses.

As will be explained in more detail below, this disclosure describes two types of modular hybrid E2E architectures: a modular hybrid partial E2E architecture, and a modular hybrid full E2E architecture. The modular hybrid partial E2E architecture enables a smooth transition from conventional modular design to hybrid systems. The modular hybrid full E2E architecture allows for joint optimization of the entire system and may provide better performance.

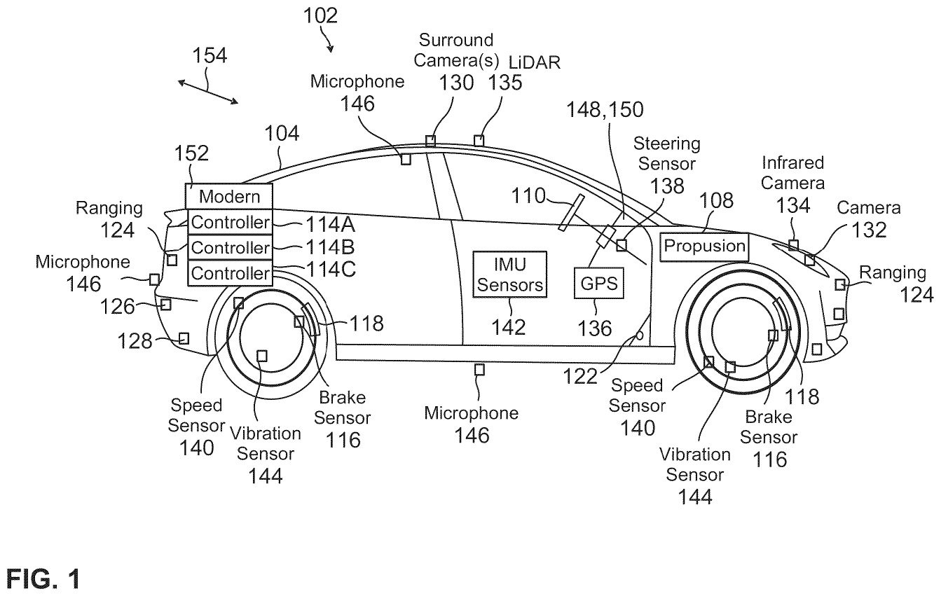

FIG. 1 is a diagram of an example vehicle, in accordance with the techniques of this disclosure. Vehicle 102 in the example shown may comprise any vehicle (such as a car, van or truck) that can accommodate a human driver and/or human passengers. Vehicle 102 may include a vehicle body 104 suspended on a chassis, in this example comprised of four wheels and associated axles.

A propulsion system 108, such as an internal combustion engine, hybrid electric power plant, or even all-electric engine, may be connected to drive some or all the wheels via a drive train, which may include a transmission (not shown). A steering wheel 110 may be used to steer some or all the wheels to direct vehicle 102 along a desired path when the propulsion system 108 is operating and engaged to propel the vehicle 102. Steering wheel 110 or the like may be optional for Level 5 implementations (e.g., for fully autonomous vehicles). One or more controllers 114A-114C (a controller 114) may provide autonomous capabilities in response to signals continuously provided in real-time from an array of sensors, as described more fully below.

Each controller 114 may be one or more onboard computer systems that may be configured to perform deep learning and/or AI functionality and output autonomous operation commands to vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide AI functionality for in-camera sensors, and controller 114D (not shown in FIG. 1) may provide infotainment functionality and provide additional redundancy for emergency situations. In other examples, all of controllers 114 may be part of a single processing system.

Controller 114 may send command signals to operate vehicle brakes (using brake sensor 116) via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”), a network inside modern vehicles used to control brakes, acceleration, steering, windshield wipers, and the like. The CAN bus may be configured to have dozens of nodes, each with its own unique identifier (CAN ID). The bus may be read to find steering wheel angle, ground speed, engine revolutions per minute (RPM), button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be provided with dedicated hardware and software, allowing control of throttle, brake, steering, and shifting. The hardware may provide a bridge between the CAN bus of vehicle 102 and the controller 114, forwarding vehicle data to controller 114 including the turn signals, wheel speed, acceleration, pitch, roll, yaw, Global Positioning System (GPS) data, tire pressure, fuel level, sonar, brake torque, and others. Similar actuation controllers may be configured for any make and type of vehicle, including special-purpose patrol and security cars, robo-taxis, long-haul trucks including tractor-trailer configurations, tiller trucks, agricultural vehicles, industrial vehicles, and buses.

One or more processing units, including neural networks, implemented by controllers 114 may provide autonomous driving outputs in response to an array of sensor inputs including, for example: one or more ranging sensors 124 (e.g., sonar, radar, ultrasonic, or other sensors), one or more surround cameras 130 (typically such cameras are located at various places on vehicle body 104 to image areas all around the vehicle body), one or more cameras 132 (in an aspect, at least one such camera may face forward to provide object recognition in the path of vehicle 102), one or more infrared cameras 134, one or more LiDAR (light detection and ranging) sensors 135, GPS unit 136 that provides location coordinates, a steering sensor 138 that detects the steering angle, speed sensors 140 (one for each of the wheels), an inertial sensor or inertial measurement unit (IMU) 142 that monitors movement of vehicle body 104 (this sensor may be, for example, an accelerometer(s) and/or a gyro-sensor(s) and/or a magnetic compass(es)), tire vibration sensors 144, and microphones 146 placed around and inside the vehicle. Other sensors may also be used. Vehicle 102 may also collect data (e.g., including sensor inputs) that is preferably used to help train and refine the neural networks implemented by controllers 114.

Controller 114 may also receive inputs from an instrument cluster 148 and may provide human-perceptible outputs to a human operator via human-machine interface (HMI) display(s) 150, an audible annunciator, a loudspeaker and/or other means. In addition to traditional information such as velocity, time, and other well-known information, HMI display may provide the vehicle occupants with information regarding maps and vehicle's location, the location of other vehicles (including an occupancy grid) and even the controller's identification of objects and status. For example, HMI display 150 may alert the passenger when the controller has identified the presence of another vehicle or other object, water puddle, stop sign, caution sign, or changing traffic light and is taking appropriate action, giving the vehicle occupants peace of mind that the controller is functioning as intended. In an aspect, instrument cluster 148 may include a separate controller/processor configured to perform deep learning and AI functionality.

It should be noted that, compared to other sensors, cameras 130-134 may generate a richer set of features at a fraction of the cost. Thus, vehicle 102 may include a plurality of cameras 130, 132, capturing images around the entire periphery of the vehicle 102. Camera type and lens selection depends on the nature and type of function. Vehicle 102 may have a mix of camera types and lenses to provide coverage around the vehicle 102; in general, narrow lenses do not have a wide field of view but can see farther. Cameras 130-134 on vehicle 102 may support interfaces such as Gigabit Multimedia Serial link (GMSL) and Gigabit Ethernet.

In some examples, cameras 130, 132 may be responsible for capturing high-resolution images and processing them in real time. The output images of such camera-based systems may be used in applications such as object detection, object velocity estimation, depth estimation, and/or pose detection, including the detection and recognition of objects, such as other vehicles, pedestrians, traffic signs, barriers, curbs, and lane markings, etc. Cameras 130, 132 may be particularly good at capturing color and texture information, which is useful for accurate object recognition and classification.

Cameras 130, 132 may generally be any type of camera configured to capture video or image data in the environment around vehicle 102. Cameras 130, 132 may include monocular, time-of-flight (ToF), and/or stereoscopic cameras. In some examples, cameras 130, 132 may be a camera system including more than one camera sensor. Cameras 130, 132 may include a front facing camera (e.g., a front bumper camera, a front windshield camera, and/or a dashcam), a back facing camera (e.g., a backup camera), side facing cameras (e.g., cameras mounted in sideview mirrors), or surround cameras. Cameras 130, 132 may include color cameras or grayscale cameras.

LiDAR sensor 135 may include one or more light emitters (e.g., lasers) and one or more light sensors. LiDAR sensor 135 may, in some cases, be deployed in or about a vehicle. For example, LiDAR sensor 135 may be mounted on a roof of a vehicle, in bumpers of a vehicle, and/or in other locations of a vehicle. LiDAR sensor 135 may be configured to emit light pulses and sense the light pulses reflected off of objects in the environment.

In some examples, the one or more light emitters of LiDAR sensor 135 may emit such pulses in a 360-degree field around the vehicle so as to detect objects within the 360-degree field by detecting reflected pulses using the one or more light sensors. For example, LiDAR sensor 135 may detect objects in front of, behind, or beside vehicle 102. While described herein as including LiDAR sensor 135, it should be understood that vehicle 102 may use another distance or depth sensing system in place of LiDAR sensor 135. The output of LiDAR sensor 135 are called point clouds or point cloud frames.

Ranging sensors 124 may include one or more of radar (radio detection and ranging) sensors, sonar (sound navigation and ranging) sensors, ultrasonic sensors, or other types of sensors. In general, ranging sensors 124 may use different techniques to measure distances and identify objects in the environment of vehicle 102, may be used in making autonomous and semi-autonomous driving decisions, such as adaptive cruise control, parking assistance, and collision avoidance.

A radar sensor uses radio waves to detect objects and determine their speed and distance from the vehicle. A radar sensor operates by emitting a radio signal which reflects off objects and returns to the radar sensor. The time it takes for the radio waves to return is used by controller 114 to calculate the distance to the object. Radar sensors are particularly effective for long-distance detection and can operate in a wide range of weather conditions, including fog, rain, and snow. Radar sensors are commonly used in adaptive cruise control systems to maintain a safe distance from the vehicle ahead.

Sonar sensors use sound waves instead of radio waves. A sonar sensor emits ultrasonic sound waves that bounce off nearby objects and return to the sensor. By measuring the time it takes for the echoes to return, controller 114 can determine the distance to and size of the objects. Sonar sensors are typically used for short-range applications such as parking assistance and blind-spot detection because sound waves have a shorter range and are more susceptible to atmospheric conditions compared to radio waves.

Ultrasonic sensors are a type of sonar sensor used specifically in automobiles for close-range detection tasks. Ultrasonic sensors emit high-frequency sound waves and controller 114 measures the echo received back to detect objects around vehicle 102. Ultrasonic sensors are effective for parking assistance systems, enabling precise maneuvering in tight spaces by alerting drivers to obstacles around the vehicle. Ultrasonic sensors can detect small objects and are useful for low-speed applications, but their utility diminishes at higher speeds or for long-range detection due to the limited range of sound waves.

The vehicle 102 may include modem 152, preferably a system-on-a-chip (SoC) that provides modulation and demodulation functionality and allows the controller 114 to communicate over the wireless network 154. Modem 152 may include a radio frequency (RF) front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, vehicle-to-everything (V2X), and other wireless data transmission standards. Modem 152 may allow for the download of additional data from a remote network (e.g., the Internet), including high-definition (HD) maps.

Although the techniques of this disclosure are described with respect to implementation in vehicle 102 (including ADAS), in other implementations the techniques may be used in drones, robots, ships, airplanes, helicopters, motorcycles, all-terrain vehicles (ATVs), or other applications involving moving objects.

As will be explained in more detail below, one or more of controllers 114 may be configured to execute an automated driving system having a modular hybrid architecture. The modular hybrid architecture includes a plurality of task units, and further includes one or more human-defined interfaces and one or more AI-defined interfaces. One or more controllers 114 may be further configured to receive input data from one or more sensors, process the input data using the automated driving system having the modular hybrid architecture, and control at least one operation of a vehicle according to an output of the automated driving system.

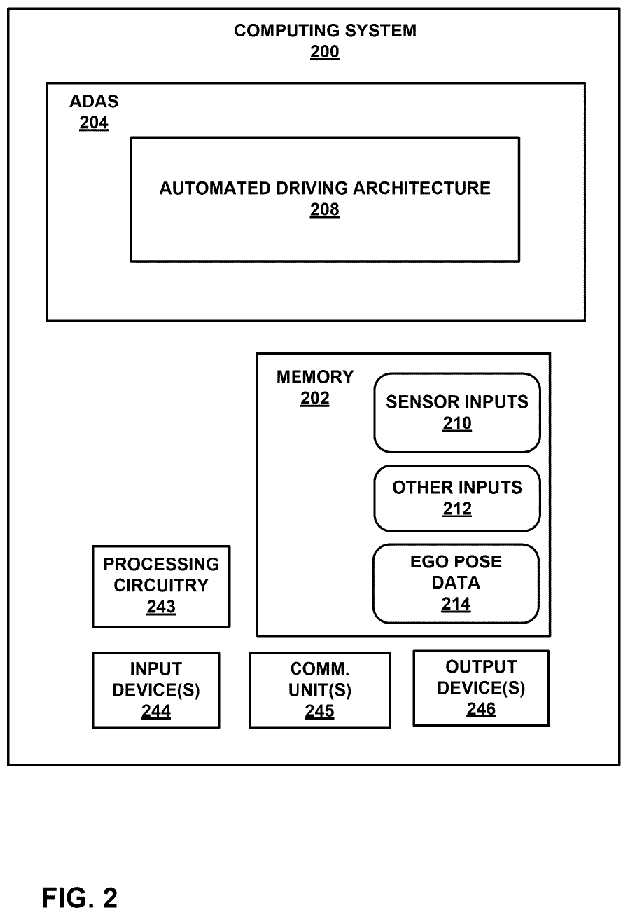

FIG. 2 is a block diagram illustrating an example computing system that may incorporate a hybrid automated driving architecture in accordance with the techniques of this disclosure. As shown, computing system 200 comprises processing circuitry 243 and memory 202 for executing ADAS 204, which may represent an example instance of any controller 114 described in this disclosure, such as controllers 114A, 114B, and 114C of FIG. 1.

While described with relation to an ADAS, the techniques of this disclosure are not limited to processing sensor data in automotive contexts. Computing system 200 may be applicable for use with any multi-camera and/or multi-sensor system that may employ multiple processing units that include neural networks in order to produce outputs. Examples may include extended reality (XR) systems, virtual reality (VR) systems, spherical or 3-D video, and others.

Computing system 200 may be configured to execute an automated driving system, such as ADAS 204. ADAS 204 may be configured for fully autonomous and/or semi-autonomous driving. As will be explained in more detail below, ADAS 204 may be configured with automated driving architecture 208. Automated driving architecture 208 may be configured with a hybrid modular architecture as described herein that includes both AI-defined and human-defined interfaces.

Computing system 200 may be implemented as any suitable computing system, such as one or more server computers, workstations, laptops, mainframes, appliances, embedded computing systems, cloud computing systems, High-Performance Computing (HPC) systems (i.e., supercomputing systems) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In an aspect, computing system 200 is disposed in vehicle 102.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure. Processing circuitry 243 may include one or more central processing units (CPUs), such as single-core or multi-core CPUs, graphics processing units (GPUs), digital signal processor (DSPs), neural processing unit (NPUs), multimedia processing units, and/or the like.

An NPU is a specialized circuit configured for implementing control and arithmetic logic for executing machine learning algorithms, such as algorithms for processing artificial neural networks (ANNs), DNNs, random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random-access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable read only memories (EPROM) or electrically erasable and programmable (EEPROM) read only memories.

Memory 202 may store program instructions and/or data associated with one or more of the modules described in accordance with one or more aspects of this disclosure. For example, memory 202 may store sensor inputs 210 (e.g., camera, LiDAR, radar, etc.), other inputs 212 (e.g., maps, redundancy data, V2X data), and ego pose data 214. Ego pose data 214 includes position and rotation data of an ego device, such as an autonomous vehicle, semi-autonomous vehicle, drone, robot, ship, airplane, helicopter, motorcycle, or ATV.

One or more input device(s) 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output device(s) 246 may generate, transmit, or process output. Examples of output are tactile, audio, visual, and/or video output. Output devices 246 may include a display, sound card, video graphics adapter card, speaker, presence-sensitive screen, one or more universal serial bus (USB) interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

Autonomous driving (AD) systems, such as an ADAS, are conventionally designed in a modular way, where the autonomous driving system is divided into modules and a module consumes the output(s) of previous module(s) and provides the input(s) for the next module(s). In autonomous driving, different modules are configured to perform different tasks. Such tasks may include object detection, object tracking through time, environmental modeling, prediction, planning, control, and others. Some of the modules may be configured to perform a particular task by implementing a neural network or other machine learning architecture.

Note that in the context of this disclosure, a module does not require implementation in software, but may be any combination of hardware, software, and/or firmware configured to perform a particular function.

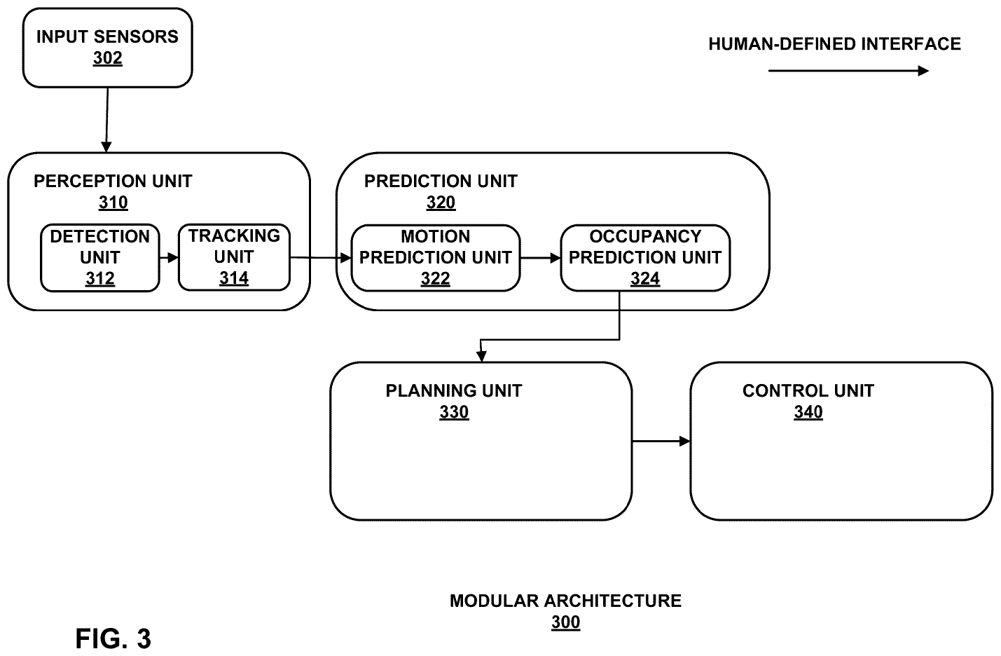

FIG. 3 is a block diagram illustrating an example modular architecture 300. In this example, modular architecture 300 receives data from input sensors 302. This data may include a plurality of camera images, LiDAR data, radar data, sonar data, GPS data, or any other data described above. Perception unit 310 is generally configured to detect objects in the environment around a vehicle. For example, detection unit 312 may detect objects in the environment, while tracking unit 314 tracks the location of objects over time.

Prediction unit 320 may generally be configured to predict the movement of objects detected by perception unit 310. Motion prediction unit 322 may predict where an object in the environment is likely to move, while occupancy prediction unit 324 may predict where in the surrounding area of the ego vehicle (e.g., vehicle) will be occupied by static or dynamic objects in the future (e.g., due to the movement of the ego vehicle or the movement of dynamic objects).

Planning unit 330 may plan how a vehicle should operate given the output of prediction unit 320, including producing a set of possible states the vehicle may be in and a distribution of actions that could be taken (e.g., braking, accelerating, turning, etc.). Control unit 340 may then be configured to control one or more actions of the vehicle based on the output of prediction unit 320.

Each module or processing task (e.g., task unit) in modular architecture 300 provides a certain output that is passed to the next module. The outputs of such modules may be well-defined human interfaces. In the context of this disclosure, a human-defined interface is defined based on human intentions (e.g., prior knowledge and experience, system requirements, safety metrics, etc.) and has real world interpretations (e.g., a bounding box around a vehicle, the object class of lane marking, etc.). Hence, data output according to a human-defined interface can provide inductive biases and simplify the training of the system. The interpretability of the output of the human-defined interface allows use for a variety of purposes (e.g., visualization, debugging, safety functions).

In some examples, human-defined interfaces may include output formats that are either undersubscribed or oversubscribed. An undersubscribed output format may include too little information for proper training and update, while an oversubscribed output format may have more information than is needed.

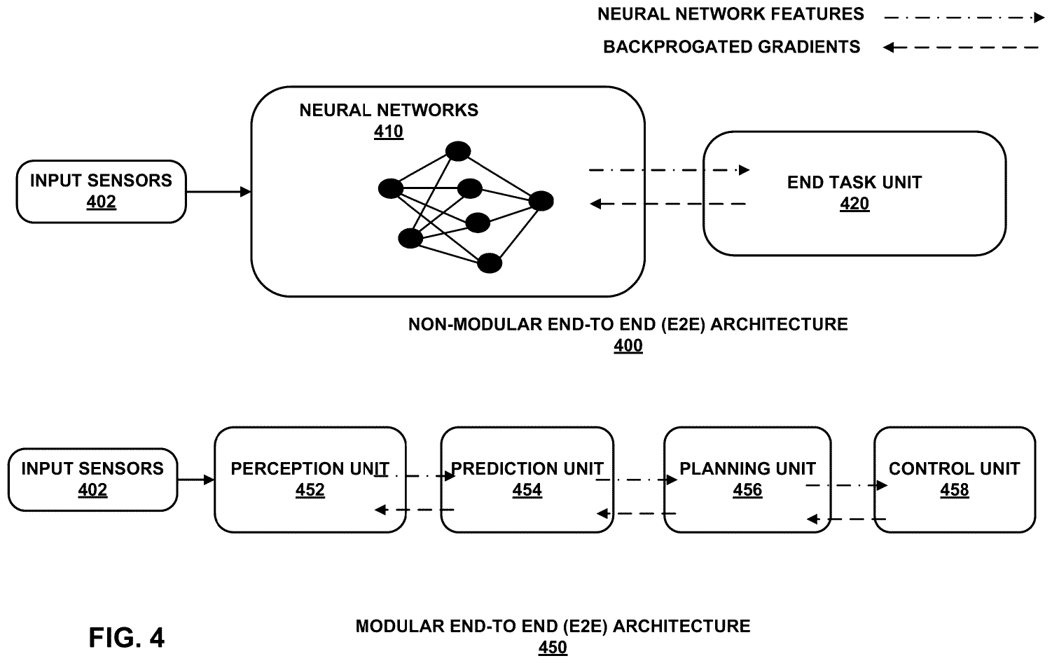

A second approach to design an automated driving system is an end-to-end (E2E) approach, where the systems use a neural network that receives input from one or more sensors and generates the final output without any intermediate module. FIG. 4 is a block diagram illustrating an example non-modular full end-to-end automated driving architecture 400. Non-modular E2E architecture 400 receives data from input sensors and neural networks 410 may be configured to perform multiple automated driving tasks (e.g., perception, prediction, planning, etc.). End task unit 420 (e.g., planning or control) may receive the output of neural networks 410 to perform some final task. End task unit 420 may receive neural network features (e.g., one or more feature tensors) from neural networks 410. The whole system of E2E architecture 400 is differentiable and may therefore be optimized through back propagation. Full E2E architectures are not limited to the non-modular example of FIG. 4.

In other examples, a full E2E architecture may a modular E2E architecture 450 and may include separate processing modules, such as perception unit 452, prediction unit 454, planning unit 456, and control unit 458, but with AI-defined interfaces between each module.

In general, fully E2E architectures use AI-defined interfaces. An AI-defined interface may be a tensor of numerical values (e.g., neural network features) that are obtained by an optimization algorithm (e.g., back propagation) to achieve a certain set of objectives.

Hence, an AI-defined interface is implicitly defined by the needs of downstream tasks. This allows the AI-defined interface to be more versatile and comprehensive than a human-defined interface, while possibly not having explicit human interpretations. In general, AI-defined interfaces are implicitly defined by an optimization process, whereas human-defined interfaces are explicitly defined by a human. In the case of a neural network, a loss function would be used to make the network adhere to this definition of the human-defined interface.

Conventional non-E2E system designs, such as modular architecture 300, are unable to optimize the full stack of processing task (e.g., consider all modules at once) and are unable to align different modules and their sometimes contradictory objectives. Typically, processing task or module of a non E2E architecture is locally optimized, ignoring any subsequent or end task(s). Each processing task or module of the non E2E architecture is optimized/evaluated against metrics that might be irrelevant or not with regard to the end goal of the system. For example, the recall or precision of an object detection module may not be the best metric to be optimized for the final planning and control module. As such, some non-E2E systems may exhibit deficient task coordination, may lose accuracy due to a growing compounding error, and may have a higher total compute cost.

Additionally, some modules of a non-E2E system are adjusted manually (e.g., based on experts guess work), which is often not data driven. Hence, updating and training a non-E2E system may be time consuming and costly. Furthermore, the planning or control module, responsible for generating steering and acceleration outputs, plays an important role in determining the driving experience. The most common approach for planning in modular pipelines, such as modular architecture 300, involves using sophisticated rule-based designs, which are often ineffective in addressing the vast number of situations that occur while driving.

E2E systems, such as non-modular E2E architecture 400 and modular E2E architectures, also exhibit drawbacks. E2E systems are typically more complex compared to non-E2E designs. Also, the safety and interpretability of an E2E system become more challenging due to lack of human interpretable interfaces. As such, troubleshooting is more involved due to lack of human interpretable interfaces. Adding and/or introducing new human-defined inputs/interfaces is not trivial. Furthermore, branching and system extension is more complex in E2E systems due to the lack of well-defined interfaces.

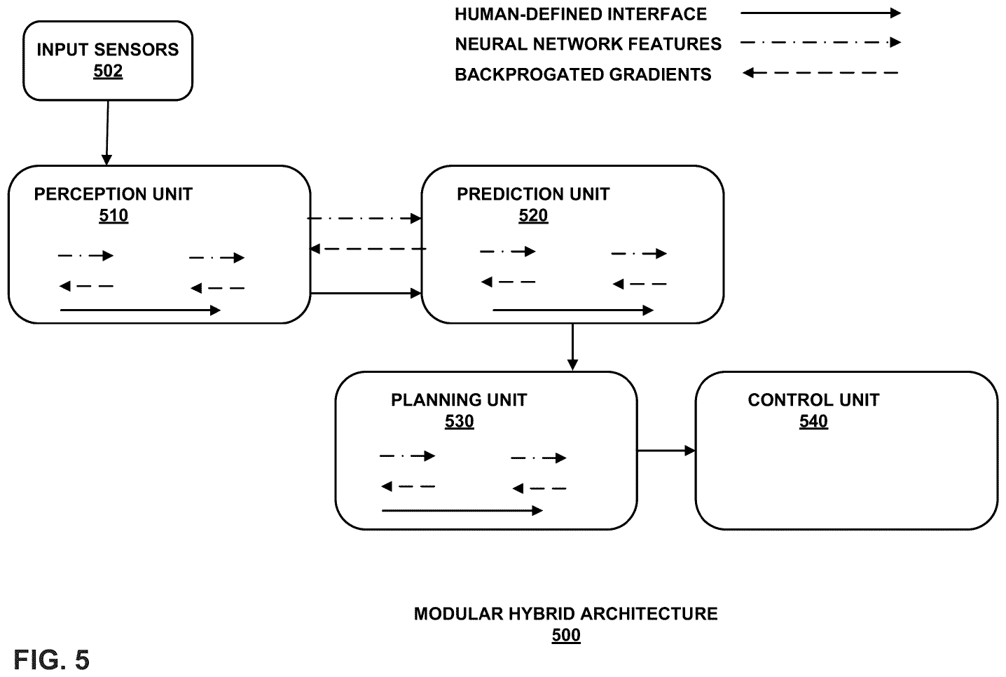

In view of these drawbacks, this disclosure describes a hybrid modular E2E architecture. FIG. 5 is a block diagram illustrating an example modular hybrid automated driving architecture 500 in accordance with the techniques of this disclosure. In general, hybrid automated driving architecture 500 receives data from input sensors 502 and processes that data through multiple processing tasks, such as perception unit 510, prediction unit 520, planning unit 530, and control unit 540. The functions of the processing tasks may be the same as described above. But rather than only using human-defined interfaces or only using AI-defined interfaces (e.g., neural network features), hybrid automated driving architecture 500 uses a combination of both human-defined interface and AI-defined interfaces, both between processing tasks, and between sub-units of a single processing task.

FIG. 5 is a generic example. Different combinations of human-defined and AI-defined interfaces may be used. In general, an AI-defined interface outputs neural network features (e.g., feature tensors) that may be directly consumed by a subsequent neural network. Relative to the inputs and outputs of neural networks with human-defined interfaces, neural networks with AI-defined interfaces in accordance with the techniques of this disclosure may have modified head layers and/or tail layers configured to handle the AI-defined data types (e.g., the feature tensors). Modular hybrid E2E architecture 500 is hybrid in that it includes both AI-defined interfaces and human-defined interfaces.

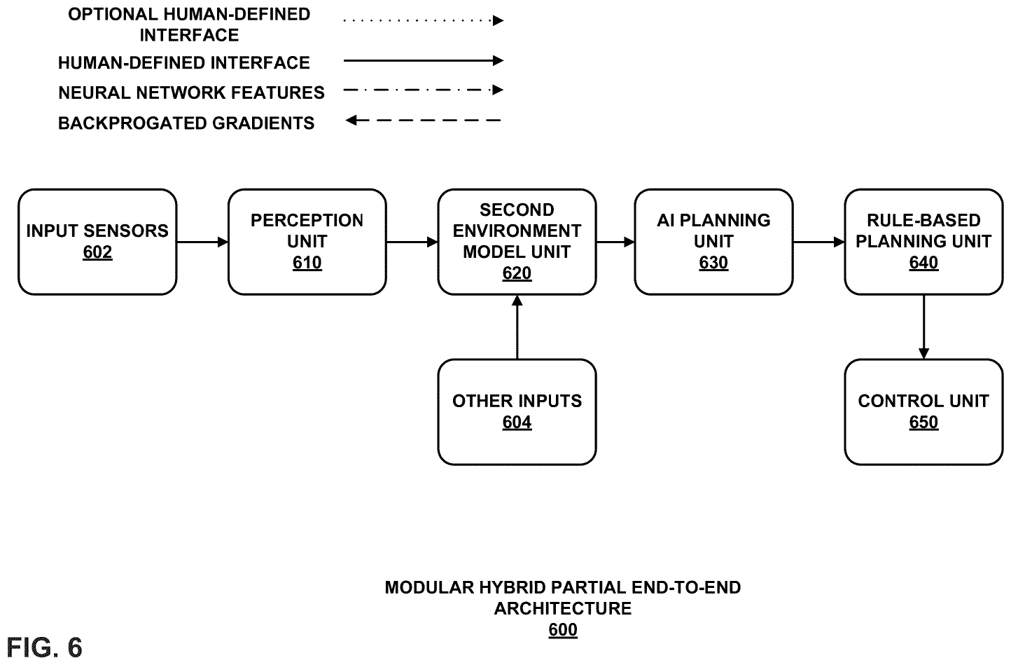

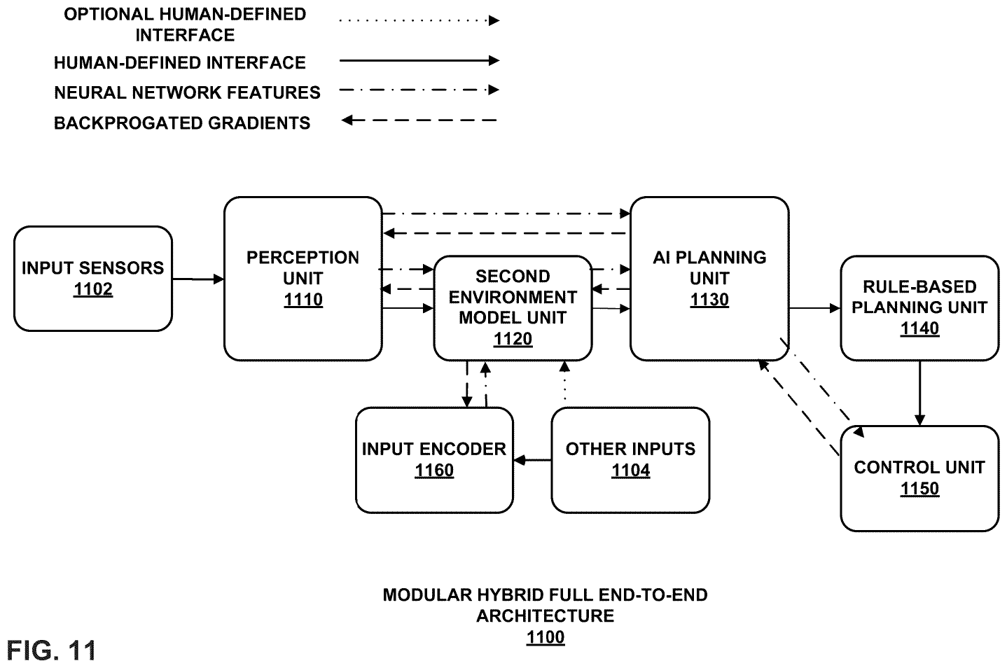

As will be explained in more detail below, this disclosure describes two types of modular hybrid architectures: a modular hybrid partial E2E architecture, and a modular hybrid full E2E architecture. The modular hybrid partial E2E architecture, described in more detail below with reference to FIGS. 6-10, enables a smooth transition from conventional modular design to the modular hybrid full E2E architecture. The modular hybrid full E2E architecture, described in more detail below with references to FIGS. 11-15, provides for a higher performance system that better harnesses the potential of E2E designs.

In one example, the modular hybrid architecture of this disclosure is inherently designed to enable seamless integration of a diverse set of inputs/human-defined interfaces (e.g., images, LiDAR data, radar data, maps, vehicle-to-everything (V2X) data, and redundant inputs like dynamic grid functions, etc.). This may be achieved by introducing a so-called second stage environment model block processing unit that fits into the hybrid design.

Due to the hybrid nature of the system, the techniques of this disclosure may address the drawbacks of conventional non-end-to-end systems and E2E systems that do not include human-defined interfaces. More specifically, the modular hybrid architecture of this disclosure may improve safety and interpretability compared to E2E systems, allow more seamless expansion of the system due to its human-defined interfaces, enable more seamless integration of inputs like high-definition (HD) maps, provide improved fallbacks thanks to its human-defined interfaces, enables safe shadow mode development, enables smart data collection by providing more flexibility to define specific data collection triggers using the human-defined interfaces, and allows for advanced customization (e.g., user-centric customization, geo-location centric customization, etc.).

The modular hybrid E2E architecture of this disclosure may utilize multi-dimensional cost functions for training multiple different processing tasks. The multi-dimensional cost function may join multiple loss functions together (e.g., weighted sums of loss that is optimized), and may include grid searches and/or Bayesian optimizations to find weights of a plurality of neural networks.

Human-defined interfaces are generally fixed. AI-defined interfaces of this disclosure may be tuned based on driver input (e.g., sport, eco, comfort, snow mode, etc.). Driver feedback can help tune the neural networks in the modular hybrid architecture of this disclosure. In some examples of the disclosure, the human-defined interfaces, when used alongside AI-defined interfaces, can be used for debugging and/or an auxiliary loss function. In some examples, human-defined interfaces may be eliminated the future systems once an automated driving system has been trained to a satisfactory level.

In one example, computing system 200 of FIG. 2 is configured to execute an automated driving system having a modular hybrid architecture, wherein the modular hybrid architecture includes a plurality of task units, and wherein the modular hybrid architecture includes one or more human-defined interfaces, and one or more AI-defined interfaces. The one or more human-defined interfaces define first inputs and first outputs of a task unit of the plurality of task units or a sub-unit of a task unit. In one example, the first inputs and first outputs are defined based on human intentions (e.g., prior knowledge and experience, system requirements, safety metrics, etc.) and have real world interpretations (e.g., a bounding box around a vehicle, the object class of lane marking, etc.). Hence, the first inputs and first outputs according to a human-defined interface can provide inductive biases and simplify the training of the system. The interpretability of the output of the human-defined interface allows use for a variety of purposes (e.g., visualization, debugging, safety functions).

The one or more AI-defined interfaces define second inputs and second outputs of a task unit of the plurality of task units or a sub-unit of the task unit. In one example, the second inputs and second outputs may include neural network features (e.g., feature tensors).

Computing system 200 is further configured to receive input data from one or more sensors, process the input data using the automated driving system having the modular hybrid architecture, and control at least one operation of a vehicle according to an output of the automated driving system.

In one example, the plurality of task units include one or more of a perception unit, a second environment model unit, an AI planning unit, a rule-planning unit, or a control unit. In a further example, one or more of the perception unit, the second environment model unit, the AI planning unit, the rule-planning unit, or the control unit include a plurality of sub-units.

FIG. 6 is a block diagram illustrating an example modular hybrid partial end-to-end architecture 600 in accordance with the techniques of this disclosure. Modular hybrid partial end-to-end architecture 600 includes input sensors 602, perception unit 610, second environment model unit 620, AI planning unit 630, rule-based planning unit 640, and control unit 650. Input sensors 602 may provide data that may include a plurality of camera images, LiDAR data, radar data, sonar data, GPS data, or any other data described above. Other inputs 604 may include maps, V2X data, and/or other redundancy data, such as dynamic grid fusions.

As will be shown in more detail in the following figures, modular hybrid partial end-to-end architecture 600 may include both AI-defined interfaces and human-defined interfaces within each processing task unit. That is, modular hybrid partial end-to-end architecture 600 may include one or more AI-defined interfaces between sub-units of at least one task unit of the plurality of task units (e.g., perception unit 610, second environment model unit 620, AI planning unit 630, rule-based planning unit 640, and control unit 650), as well as human-defined interfaces between some of such sub-units. Modular hybrid partial end-to-end architecture 600 uses human-defined interfaces between the plurality of task units.

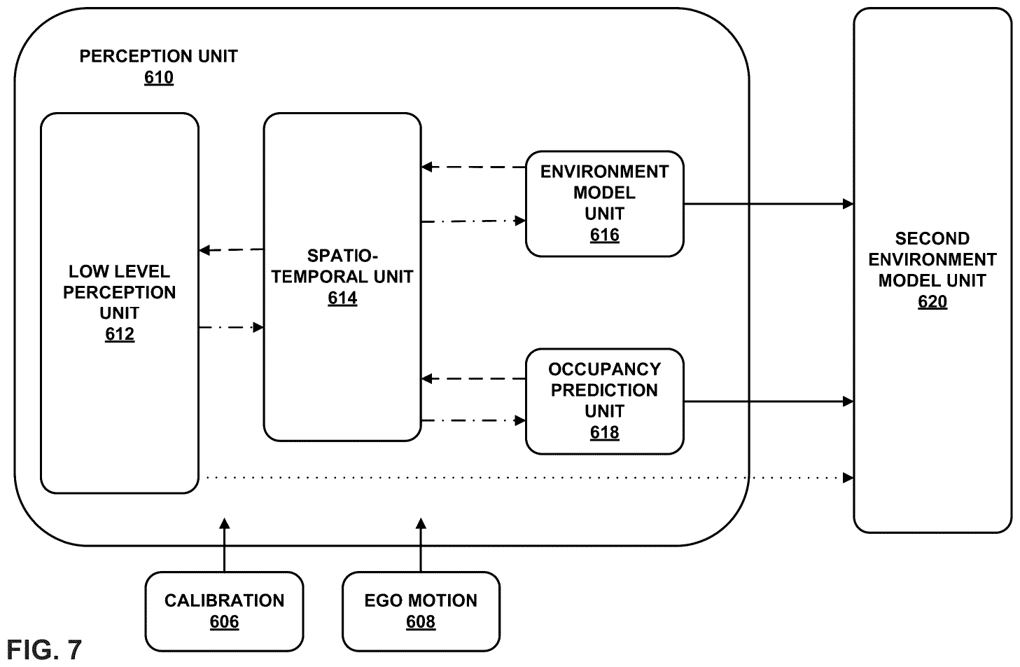

FIG. 7 is a block diagram illustrating an example architecture for a perception unit 610 of FIG. 6 in more detail. Perception unit 610 is the core perception block of modular hybrid partial end-to-end architecture 600. Perception unit 610 may include low level perception unit 612, spatio-temporal unit 614, environment model unit 616, and occupancy prediction unit 618. Perception unit 610 receives input data from input sensors 602, as well as calibration data 606 and ego motion data 608.

In general, perception unit 610 generates an E2E AI-tracked environment model which improves stack and map harvesting. Perception unit 610 is configured with AI-defined interfaces between low level perception unit 612 and spatio-temporal unit 614. Perception unit 610 is further configured with AI-defined interfaces between spatio-temporal unit 614 and environment model unit 616 as well as occupancy prediction unit 618. In this way, gradients based on the output of environment model unit 616 and occupancy prediction unit 618 may be backpropagated to spatio-temporal unit 614, and eventually low level perception unit 612, thus allowing for training of such sub-units, and simultaneous optimization of the interfaces between them, based on the outputs achieved by the environment model and occupancy prediction.

Both environment model unit 616 and occupancy prediction unit 618 are configured with human-defined interfaces to second environment model unit 620. In addition, low level perception unit 612 may include an optional human-defined interface to second environment model unit 620.

In one example, low level perception (LLP) unit 612 is a neural network that uses birds eye view (BEV) representations to process and fuse input sensors (e.g., camera, Radar, Lidar, etc.) in a centralized manner. Low level perception unit 612 may operate on a per frame basis.

Spatio-temporal unit 614 performs perform spatial adjustment of features of previous frames received from low level perception unit 612, and then concatenates spatially adjusted BEV features of past frames and the current BEV feature map. Spatio-temporal unit 614 may also aggregate BEV features of current and past frames in a single BEV feature representation.

Environment model unit 616 is a neural net that decode features and constructs an environment model for objects (e.g., vehicles, vulnerable road users, etc.) and road features (e.g., roads, lanes, lane markings, etc.).

Occupancy (flow) prediction unit 618 generates a grid around the ego vehicle and populates attributes for each cell of the grid. Attributes may include whether the cell is occupied, if there is a static or dynamic object in the cell, and what is the speed or acceleration in the cell, etc. In some examples, occupancy prediction unit 618 may be considered as an optional output.

Calibration data 606 and ego motion data 608 may provide information used by both low level perception unit 612 and spatio-temporal unit 614.

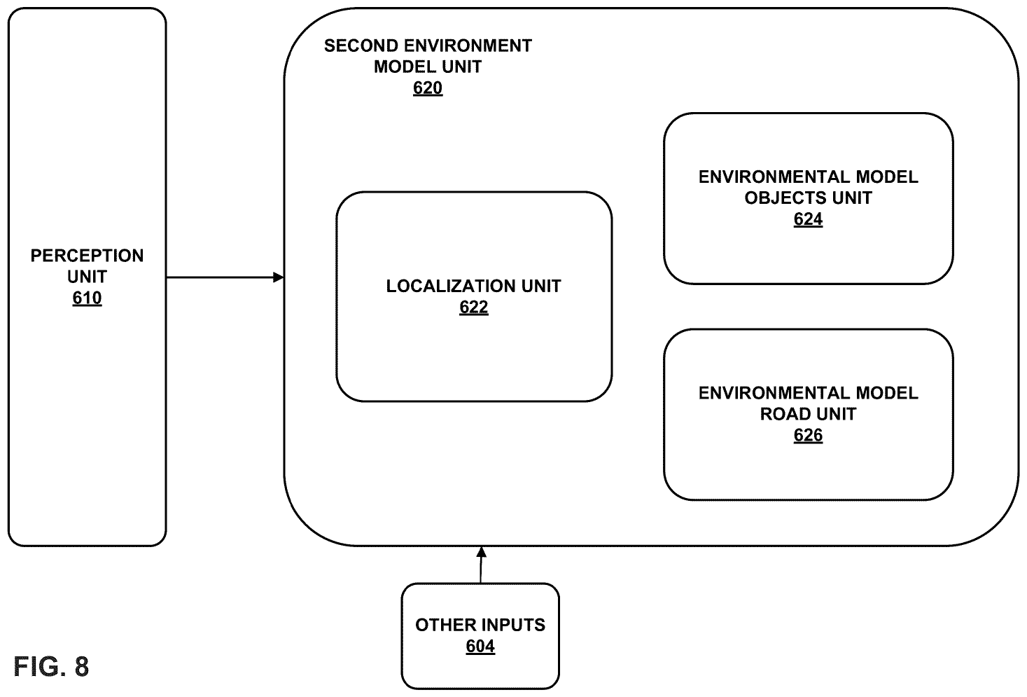

FIG. 8 is a block diagram illustrating an example architecture for a second environment model unit 620 of FIG. 6 in more detail. Second environment model unit 620 enables a more seamless integration of a diverse set of other inputs 604 (e.g., Maps, V2X, non-parametric redundancy perception modules, etc.). Second environment model unit 620 seamlessly integrates a diverse set of inputs from different vendors, and is designed such that the system remains functional in case such inputs are not available. One example may be rural roads where HD maps do not exist. Second environment model unit 620 may also improve the performance of the overall modular hybrid architecture. For example, second environment model unit 620 enables the integration of an HD map with fresh online road model generated by the perception unit 610 to generate more accurate road models. Such a decoupling of inputs (e.g., map) from the core perception task may enable meeting higher safety standards.

The second environment model unit 620 may include localization unit 622, environmental model objects unit 624, and environmental model road unit 626.

Localization unit 622 localizes the ego vehicle in the static map. Environmental model objects unit 624 uses redundant perception, other inputs like V2X, and the object model received from perception unit 610 to update the environment model by adding the objects. Given a static map, redundant perception, other inputs like V2X, and the model received from the perception unit 610, environmental model road unit 626 constructs a more accurate road model. Environmental model road unit 626 may use deep learning (DL) based approaches as well as rule-based approaches.

Other inputs 604 may include maps, V2X data, and redundant perception data. The maps may an HD map or any other form of maps.

V2X data is a broad term used in the context of autonomous driving and smart transportation systems. V2X data may refers to the communication technology that enables vehicles to interact with each other and with various elements of the transportation system, including infrastructure, pedestrians, cyclists, and the internet. One goal of V2X communication is to enhance road safety, improve traffic efficiency, and support the various levels of vehicle automation. V2X may encompass several types of communications, such as vehicle-to-vehicle (V2V) data, vehicle-to-infrastructure (V2I) data, vehicle-to-pedestrian (V2P) data, vehicle-to-network (V2N) data, and/or vehicle-to-grid (V2G) data.

Redundant perception data may include redundant perception inputs to the system. One example of redundant perception data is Dynamic Grid Fusion (DGF). DGF is a non-parametric (e.g., non-machine learning) representation of the environment constructed from sensor inputs (e.g., Radar). DGF provides a grid where each cell in the grid has different attributes (e.g., static object, dynamic object, free space, position and velocity for dynamic objects, etc.). In other examples, redundant perception data may further include asymmetric stereo data that provides a geometric representation of the environment. The asymmetric stereo data may be used to detect objects sticking out from the ground in the area of overlapping fields-of-view (FOV) of any of cameras 130, 132, and 134 (see FIG. 1).

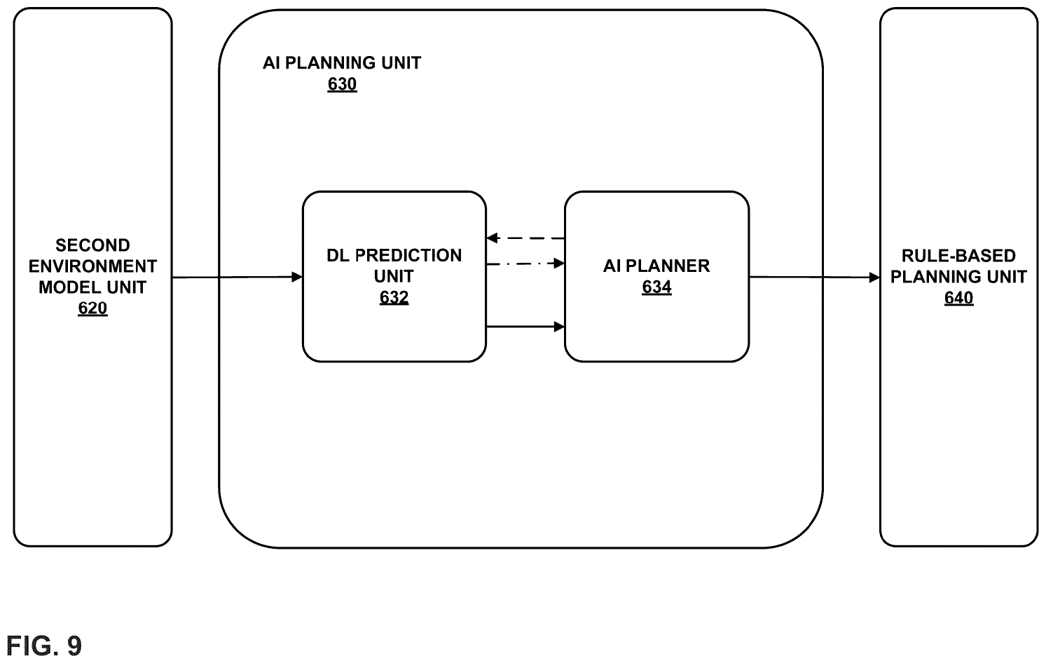

FIG. 9 is a block diagram illustrating an example architecture for AI planning unit 630 of FIG. 6 in more detail. AI planning unit 630 receives input from second environment model unit 620 via a human-defined interface and provides an output to rule-based planning unit 640 via a human-defined interface. AI planning unit 630 may include a deep learning (DL) prediction unit 632 and an AI planner 634. DL prediction unit 632 and AI planner 634 may be connected by both AI-defined and human-defined interfaces. In this way, DL prediction unit 632 and AI planner 634, and thereby the AI defined part of the interface between them, can be optimized simultaneously.

DL prediction unit 632 is configured to perform a series of predictions including, but not limited to, predicting the future for all agents received from second environment model unit 620, and then producing a set of possible states and actions distributions. Given the predictions from DL prediction unit 632, AI planner 634 generates low level outputs (e.g., possible future trajectories) or high level policies and actions.

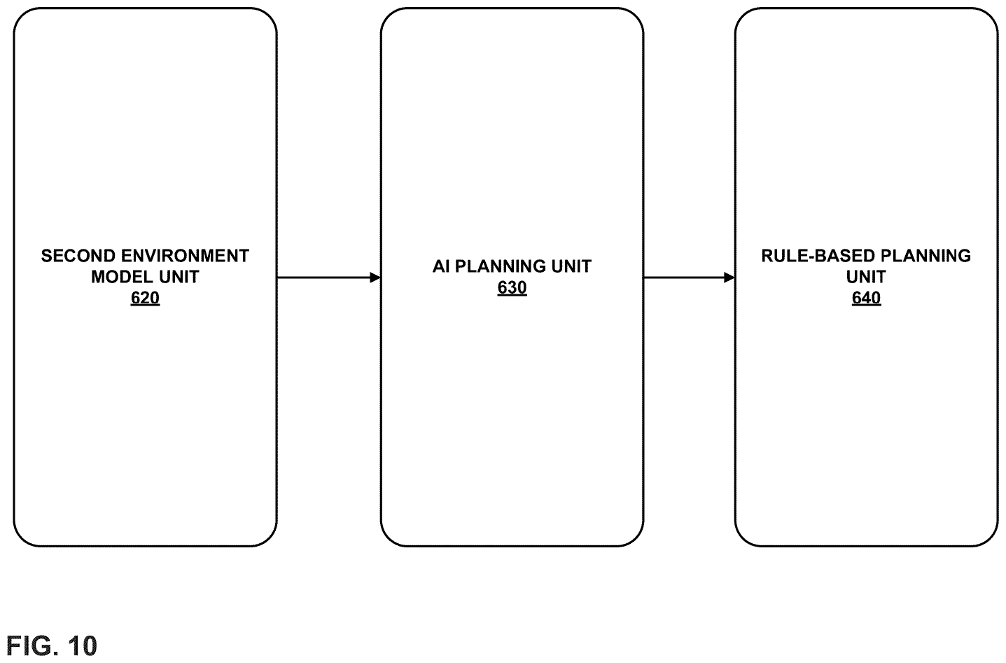

FIG. 10 is a block diagram illustrating an example architecture for rule-based planning unit 640 of FIG. 6 in more detail. Rule-based planning unit 640 may receive input from AI planning unit 630 via a human-defined interface. Rule-based planning unit 640 may, given the possible trajectories or policies/actions received from AI planning unit 630, perform rule-based safety mechanisms to rule out unsafe trajectories, check the feasibility of the proposed trajectory (e.g., align with the physics of the ego vehicle), and select one feasible and safe trajectory/policy/action that matches human preferences (e.g., comfort, sport, safety, etc.).

FIG. 11 is a block diagram illustrating an example modular hybrid full end-to-end automated driving architecture 1100 in accordance with the techniques of this disclosure. Modular hybrid full end-to-end architecture 1100 includes input sensors 1102, perception unit 1110, second environment model unit 1120, AI planning unit 1130, rule-based planning unit 1140, control unit 1150, and input encoder 1160. Unless otherwise described below, the functions of each of these task units is the same as that described above with reference to FIGS. 6-10. Modular hybrid full end-to-end architecture 1100 may include both AI-defined interfaces and human-defined interfaces within each processing task unit. That is, modular hybrid full end-to-end architecture 1100 may include one or more AI-defined interfaces between sub-units of at least one task unit of the plurality of task units (e.g., perception unit 1110, second environment model unit 1120, AI planning unit 1130, rule-based planning unit 1140, control unit 1150, and input encoder 1160), as well as human-defined interfaces between some of such sub-units.

However, unlike the example of FIG. 6, modular hybrid full end-to-end architecture 1100 uses both AI-defined interfaces and human-defined interfaces between the plurality of task units. For example, modular hybrid full end-to-end architecture 1100 may include an AI-defined interface between perception unit 1110 and second environment model unit 1120, an AI-defined interface between perception unit 1110 and AI planning unit 1130, an AI-defined interface between second environment model unit 1120 and AI planning unit 1130, an AI-defined interface between input encoder 1160 and second environment model unit 1120, and an AI-defined interface between AI planning unit 1130 and control unit 1150. As such, in some examples, modular hybrid full E2E architecture 1100 may be fully E2E through the control unit.

Compared to the partial approach of FIGS. 6-10, modular hybrid full end-to-end architecture 1100 allows the flow of features (in forward pass) and gradients (in backward pass) between blocks. The features of the AI-defined interfaces can be passed from any sub-unit of one task unit to a sub-unit of other task units. For example, modular hybrid full end-to-end architecture 1100 may be configured to directly pass the spatio-temporal features from perception unit 1110 to AI planning unit 1130, or both spatio-temporal features and occupancy features to AI planning unit 1130.

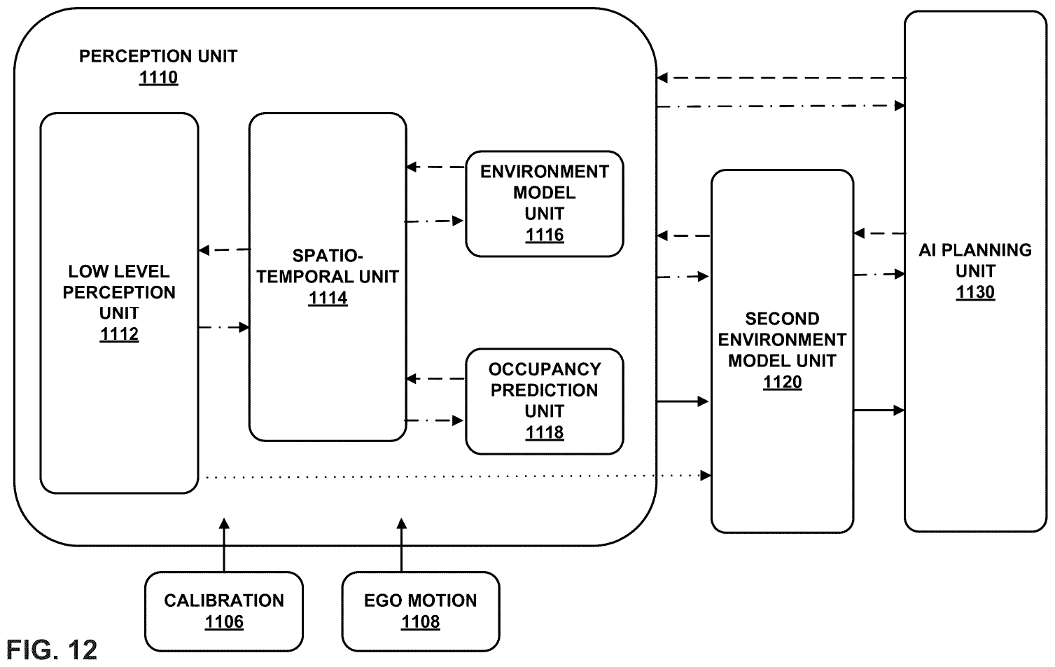

FIG. 12 is a block diagram illustrating an example architecture for perception unit 1110 of FIG. 11 in more detail. As shown in FIG. 12, and in contrast to the example of FIG. 7, perception unit 1110 includes AI defined interfaces between both second environment model unit 1120 and AI planning unit 1130. Compared with the partial approach of FIG. 7, perception unit 1110 passes the feature maps in forward pass to (and the gradients in backward pass from) to second environment model unit 1120. An optional human-defined interface from low level perception unit 1112 and second environment model unit 1120 enables fallback towards modular systems and may be used as a safety verification parallel system.

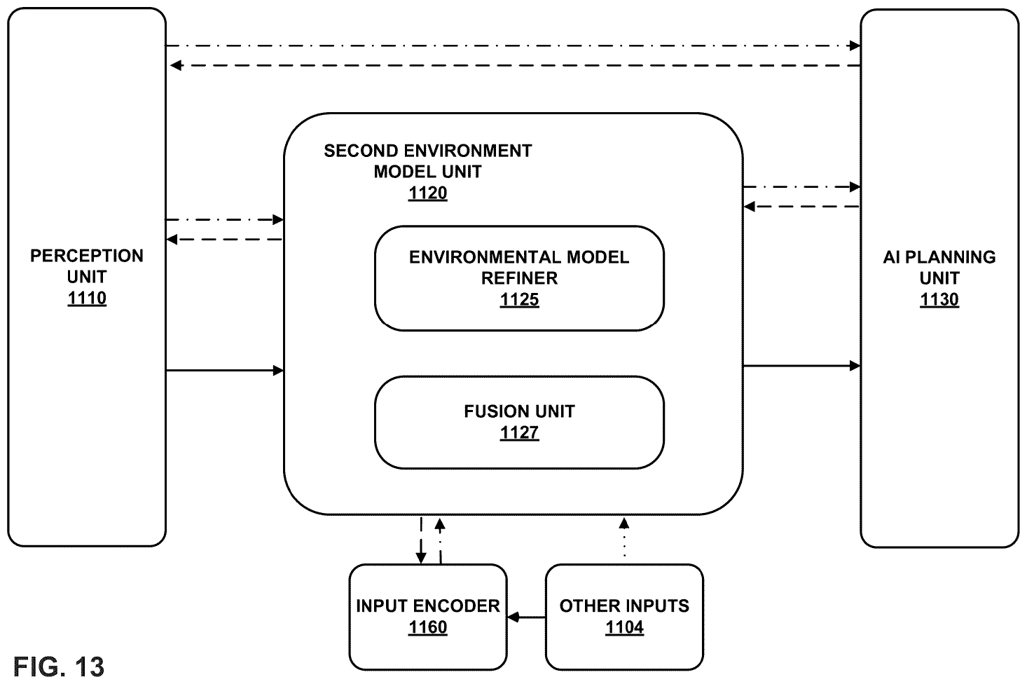

FIG. 13 is a block diagram illustrating an example architecture for second environment model unit 1120 of FIG. 11 in more detail. In FIG. 13, second environment model unit 1120 includes an AI-defined interface between both AI planning unit 1130 and input encoder 1160. Input encoder 1160 may be configured to receive inputs, such as an HD map, V2X, and DGF, from other inputs 1104 via a human-defined interface and integrate such inputs into a feature representation to be consumed by the second environment model unit 1120.

Second environment model unit 1120 includes environmental model refiner 1125 and fusion unit 1127. Fusion unit 1127 fuses the differentiable feature representation received from input encoder 1160 with the representation produced by environment model unit 1116 and the occupancy feature representation generated by occupancy prediction unit 1118. The fused features produced by fusion unit 1127 may be passed to the AI planning unit 1130 via an AI-defined interface, as well as an optional human-defined interface. Environmental model refiner 1125 may be configured as a non-parametric module (e.g., rule based or optimization based) that refines the human-defined interface of perception unit 1110 using the map data received from input encoder 1160, and passes the refined data to AI planning unit 1130 via a human-defined interface.

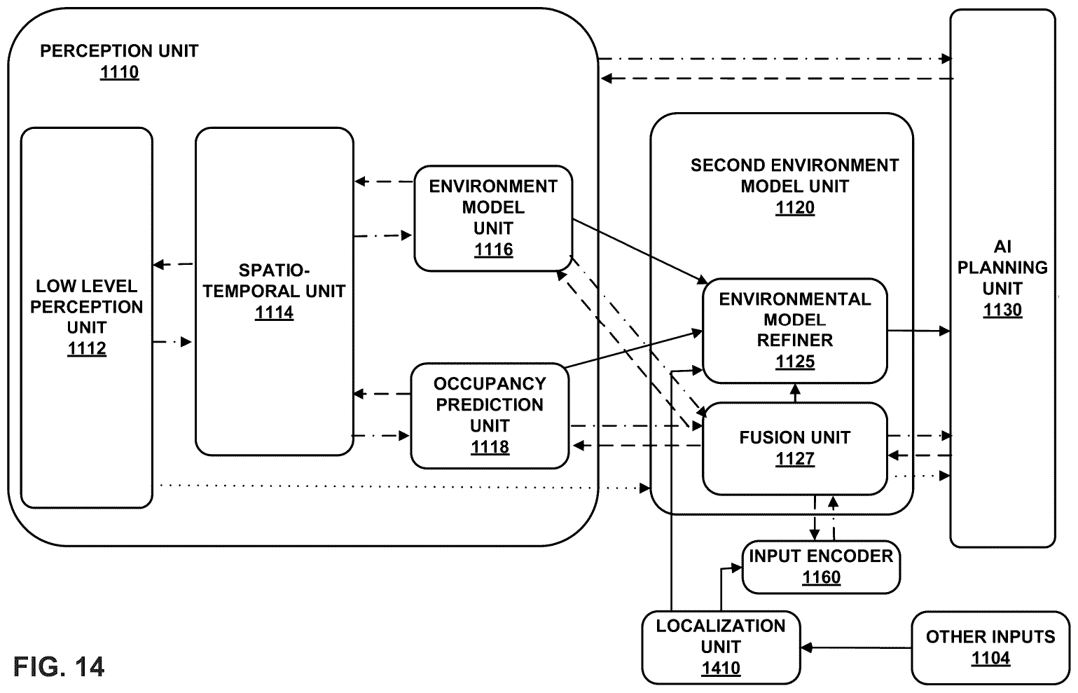

FIG. 14 is a block diagram illustrating another example architecture for perception unit 1110 and second environment model unit 1120 of FIG. 11 in more detail. In this example, modular hybrid full end-to-end architecture 1100 may further include a localization unit 1410. Localization unit 1410 may localize a map received from other inputs 1104 with respect the ego vehicle. This localization may be provided to both environmental model refiner 1125 and input encoder 1160 via human-defined interface. Input encoder 1160 receives the localized map from localization unit 1410 and generates a differentiable feature representation of the localized map.

In the example of FIG. 14, second environment model unit 1120 includes environmental model refiner 1125 and fusion unit 1127. Fusion unit 1127 fuses the differentiable feature representation received from input encoder 1160 with the representation produced by environment model unit 1116 and the occupancy feature representation generated by occupancy prediction unit 1118, both received via AI-defined interfaces. This example can be a cross attention module. The fused features produced by fusion unit 1127 are passed to the AI planning unit 1130 via an AI-defined interface, as well as an optional human-defined interface.

Environmental model refiner 1125 receives the localized map from localization unit 1410 as well as the outputs of environment model unit 1116 and occupancy prediction unit 1118 via human-defined interfaces. Environmental model refiner 1125 further receives an input from fusion unit 1127. Environmental model refiner 1125 may be configured as a non-parametric module (e.g., rule based or optimization based) that refines the human-defined interface of perception unit 1110 using the map data, and passes the refined data to AI planning unit 1130 via a human-defined interface.

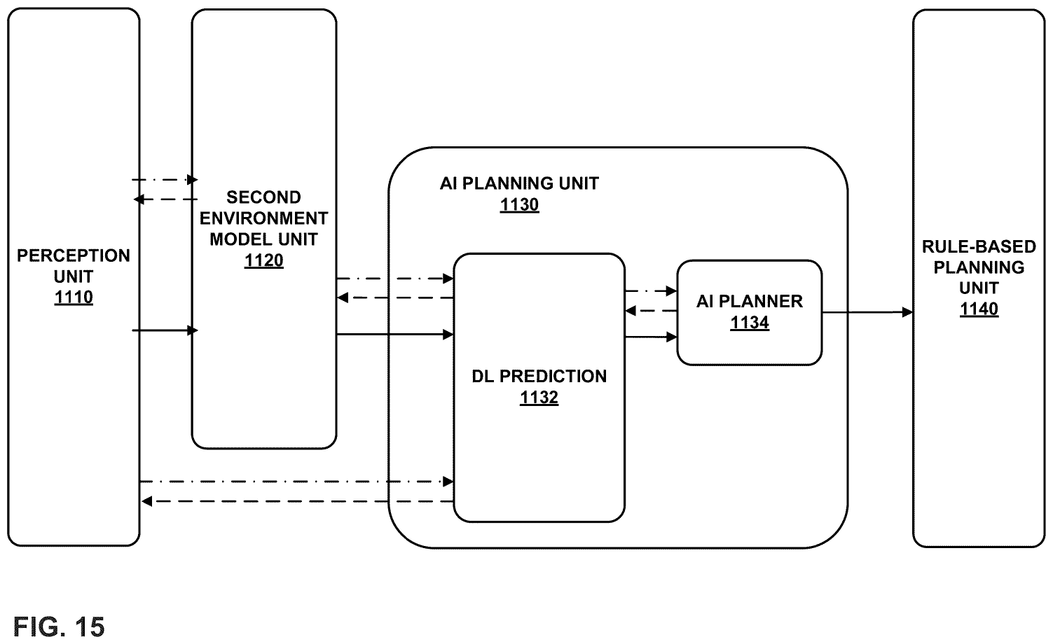

FIG. 15 is a block diagram illustrating an example architecture for AI planning unit 1130 of FIG. 11 in more detail. This example shows DL prediction unit 1132 receiving inputs from perception unit 1110 via an AI-defined interface. In addition, DL prediction unit 1132 may receive inputs from second environment model unit 1120 via both AI-defined and human-defined interfaces.

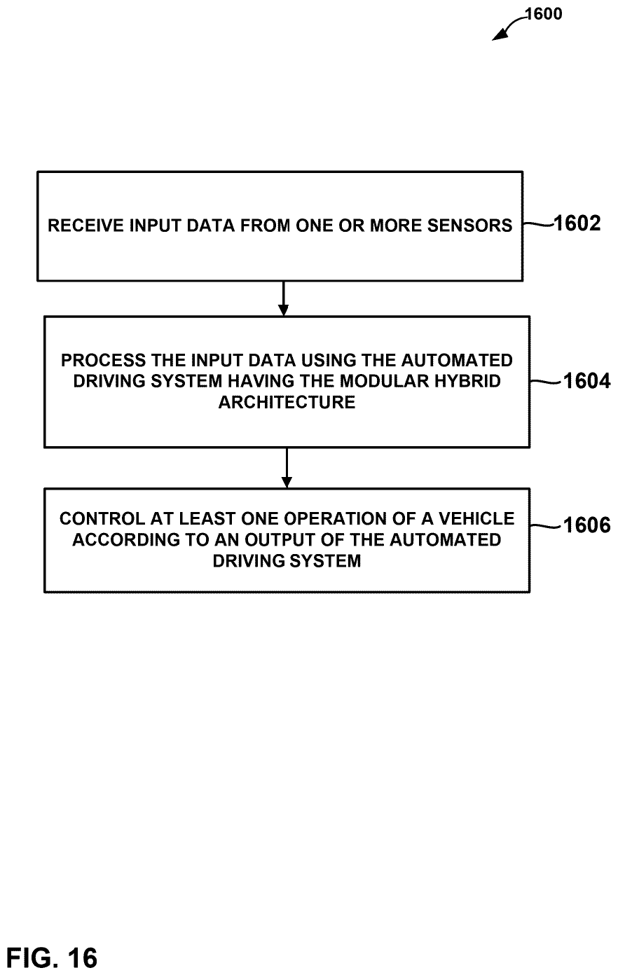

FIG. 16 is a flow diagram illustrating an example method 1600 in accordance with the techniques of this disclosure. The techniques of FIG. 16 may be performed by computing system 200 of FIG. 2.

In one example, computing system 200 of FIG. 2 is configured to execute an automated driving system having a modular hybrid architecture, wherein the modular hybrid architecture includes a plurality of task units, and wherein the modular hybrid architecture includes one or more human-defined interfaces, and one or more AI-defined interfaces. The one or more human-defined interfaces define first inputs and first outputs of a task unit of the plurality of task units or a sub-unit of a task unit. The one or more AI-defined interfaces define second inputs and second outputs of a task unit of the plurality of task units or a sub-unit of the task unit. For example, the second inputs and second outputs may include neural network features.

Computing system 200 is further configured to receive input data from one or more sensors (1602), process the input data using the automated driving system having the modular hybrid architecture (1604), and control at least one operation of a vehicle according to an output of the automated driving system (1606).

In one example, the plurality of task units include one or more of a perception unit, a second environment model unit, an AI planning unit, a rule-planning unit, or a control unit. In a further example, one or more of the perception unit, the second environment model unit, the AI planning unit, the rule-planning unit, or the control unit include a plurality of sub-units.

In one example, the modular hybrid architecture is a modular hybrid partial end-to-end architecture, the one or more human-defined interfaces are between the plurality of task units, and the one or more AI-defined interfaces are between sub-units of at least one task unit of the plurality of task units. In one example, the perception unit includes a low level perception sub-unit, a spatio-temporal sub-unit, a first environment model sub-unit, and an occupancy prediction sub-unit, and the modular hybrid partial end-to-end architecture includes the AI-defined interface between the perception sub-unit and the spatio-temporal sub-unit, the AI-defined interface between the spatio-temporal sub-unit and the first environment model sub-unit, and the AI-defined interface between the spatio-temporal sub-unit and the occupancy prediction sub-unit. In another example, the AI planning unit includes a deep learning (DL) prediction sub-unit and an AI planner sub-unit, and the modular hybrid partial end-to-end architecture includes the AI-defined interface between the DL prediction sub-unit and the AI planner sub-unit.

In another example of the disclosure, the modular hybrid architecture is a modular hybrid full end-to-end architecture, and the one or more human-defined interfaces are between at least two task units of the plurality of task units, the one or more AI-defined interfaces are between at least two task units the plurality of task units, and the one or more AI-defined interfaces are between sub-units of at least one task unit of the plurality of task units.

In one example, the modular hybrid full end-to-end architecture includes the AI-defined interface between the perception unit and the second environment model unit, and includes the AI-defined interface between the perception unit and the AI planning unit. In another example, the modular hybrid full end-to-end architecture includes the AI-defined interface between the second environment model unit and the AI planning unit. In another example, the modular hybrid full end-to-end architecture includes the AI-defined interface between the second environment model unit and a map encoder.

The following numbered clauses illustrate one or more aspects of the devices and techniques described in this disclosure.

The architectures shown above show several examples where task units with human-defined interfaces are altered to use AI-defined interfaces. In other examples, task units with AI-defined interfaces are altered to use human-defined interfaces.

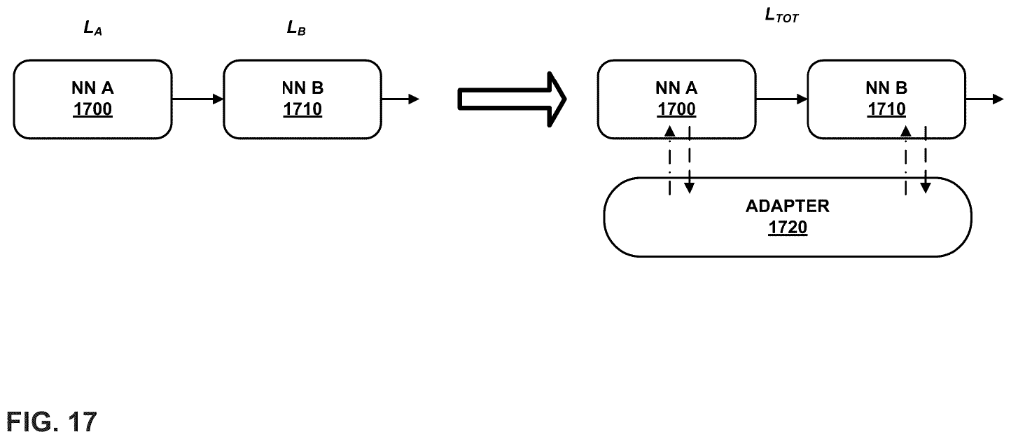

FIG. 17 is a conceptual diagram illustrating an example of adding an AI-defined interface to neural networks with a human-defined interface. In FIG. 17, neural network (NN) A 1700 is a neural network configured to perform a particular task. NN B 1710 is another neural network configured to perform a different task using the output of NN A 1700. On the left, NN A 1700 and NN B 1710 are connected via a human-defined interface. Each of NN A 1700 and NN B 1710 are trained by a loss function (e.g., L_{A} and L_{B}, respectively) that are independent of each other. The right side of FIG. 17 illustrates one example technic of adding an AI-defined interface between NN A 1700 and NN B 1710.

Adapter 1720 may be configured to take the output features (e.g., intermediate features) of an intermediate layer of NN A 1700 via an AI-defined interface. In one simple example, such output features may be the output of a single layer. Adapter 1720 is a differentiable module. The output of adapter 1720 is passed to a set of intermediate layers of NN B 1710 via an AI-defined interface. A new loss L_{TOT} may then be used for the system, where L_{TOT}=L_{B}+αL_{A}+BLₐᵤₓ, where α and β are loss weights that may be found by grid search, Bayesian search, or learned via backpropagation. Lₐᵤₓ can be used for regularization or to enforce consistency between NN A 1700 and NN B 1710. The loss L_{TOT} may be used to train the whole system in an E2E manner. NN A 1700 and NN B 1710 may be trained at the same time.

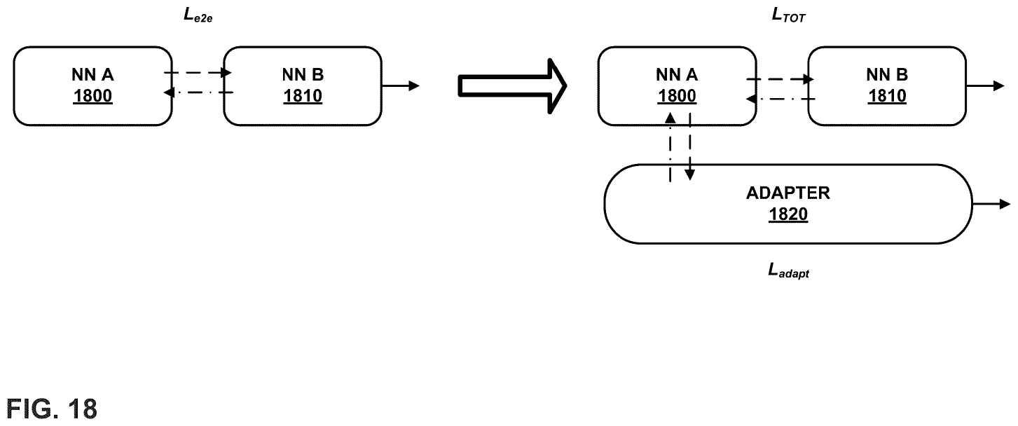

FIG. 18 is a conceptual diagram illustrating an example of adding a human-defined interface to neural networks with an AI-defined interface. In FIG. 18, NN A 1800 is a neural network configured to perform a particular task. NN B 1810 is another neural network configured to perform a different task using the output of NN A 1800. On the left, NN A 1800 and NN B 1810 are connected via an AI-defined interface in an E2E system. The right half of FIG. 18 shows a human-defined interface being added to this system.

Adapter 1820 may be configured to take the output features (e.g., intermediate features) of an intermediate layer of NN A 1800 via an AI-defined interface. In one simple example, such output features may be the output of a single layer. Adapter 1820 is a differentiable module that is configured to output these intermediate features in a data format according to the human-defined interface. A loss function for adapter 1820 may be defined as L_{adapt}. The total loss of the system on the right side of FIG. 18 may be L_{TOT}=L_{adapt}+αLₑ₂₃, where α is a loss weight than be found by grid search, Bayesian search, or learned via backpropagation

Clause 1. An apparatus comprising: one or more memories; and one or more processors in communication with the one or more memories, the one or processors configured to execute an automated driving system having a modular hybrid architecture, wherein the modular hybrid architecture includes a plurality of task units, and wherein the modular hybrid architecture includes one or more human-defined interfaces, and one or more AI-defined interfaces, and wherein the one or more processors are configured to: receive input data from one or more sensors; process the input data using the automated driving system having the modular hybrid architecture; and control at least one operation of a vehicle according to an output of the automated driving system.

Clause 2. The apparatus of Clause 1, wherein the one or more AI-defined interfaces include neural network features.

Clause 3. The apparatus of any combination of Clauses 1-2, wherein the plurality of task units include one or more of a perception unit, a second environment model unit, an AI planning unit, a rule-planning unit, or a control unit.

Clause 4. The apparatus of any combination of Clauses 1-3, wherein one or more of the perception unit, the second environment model unit, the AI planning unit, the rule-planning unit, or the control unit include a plurality of sub-units.

Clause 5. The apparatus of any combination of Clauses 1-4, wherein the modular hybrid architecture is a modular hybrid partial end-to-end architecture, and wherein the one or more human-defined interfaces are between the plurality of task units, and wherein the one or more AI-defined interfaces are between sub-units of at least one task unit of the plurality of task units.

Clause 6. The apparatus of Clause 5, wherein the perception unit includes a low level perception sub-unit, a spatio-temporal sub-unit, a first environment model sub-unit, and an occupancy prediction sub-unit, and wherein the modular hybrid partial end-to-end architecture includes the AI-defined interface between the perception sub-unit and the spatio-temporal sub-unit, the AI-defined interface between the spatio-temporal sub-unit and the first environment model sub-unit, and the AI-defined interface between the spatio-temporal sub-unit and the occupancy prediction sub-unit.

Clause 7. The apparatus of any combination of Clauses 5-6, wherein the AI planning unit includes a deep learning (DL) prediction sub-unit and an AI planner sub-unit, and wherein the modular hybrid partial end-to-end architecture includes the AI-defined interface between the DL prediction sub-unit and the AI planner sub-unit.

Clause 8. The apparatus of any combination of Clauses 1-4, wherein the modular hybrid architecture is a modular hybrid full end-to-end architecture, and wherein the one or more human-defined interfaces are between at least two task units of the plurality of task units, wherein the one or more AI-defined interfaces are between at least two task units the plurality of task units, and wherein the one or more AI-defined interfaces are between sub-units of at least one task unit of the plurality of task units.

Clause 9. The apparatus of Clause 8, wherein the modular hybrid full end-to-end architecture includes the AI-defined interface between the perception unit and the second environment model unit, and includes the AI-defined interface between the perception unit and the AI planning unit.

Clause 10. The apparatus of any combination of Clauses 8-9, wherein the modular hybrid full end-to-end architecture includes the AI-defined interface between the second environment model unit and the AI planning unit.

Clause 11. The apparatus of any combination of Clauses 8-10, wherein the modular hybrid full end-to-end architecture includes the AI-defined interface between the second environment model unit and a map encoder.

Clause 12. The apparatus of any of Clauses 1-11, wherein the automated driving system is part of an advanced driver assistance system (ADAS).

Clause 13. The apparatus of any of Clauses 1-12, further comprising the vehicle.

Clause 14. A method comprising: executing an automated driving system having a modular hybrid architecture, wherein the modular hybrid architecture includes a plurality of task units, and wherein the modular hybrid architecture includes one or more human-defined interfaces, and one or more AI-defined interfaces, and wherein executing the automated driving system having the modular hybrid comprises: receiving input data from one or more sensors; processing the input data using the automated driving system having the modular hybrid architecture; and controlling at least one operation of a vehicle according to an output of the automated driving system.

Clause 15. The method of Clause 14, wherein the one or more AI-defined interfaces include neural network features.

Clause 16. The method of any combination of Clauses 14-15, wherein the plurality of task units include one or more of a perception unit, a second environment model unit, an AI planning unit, a rule-planning unit, or a control unit.

Clause 17. The method of any combination of Clauses 14-16, wherein one or more of the perception unit, the second environment model unit, the AI planning unit, the rule-planning unit, or the control unit include a plurality of sub-units.

Clause 18. The method of any combination of Clauses 14-17, wherein the modular hybrid architecture is a modular hybrid partial end-to-end architecture, and wherein the one or more human-defined interfaces are between the plurality of task units, and wherein the one or more AI-defined interfaces are between sub-units of at least one task unit of the plurality of task units.

Clause 19. The method of Clause 18, wherein the perception unit includes a low level perception sub-unit, a spatio-temporal sub-unit, a first environment model sub-unit, and an occupancy prediction sub-unit, and wherein the modular hybrid partial end-to-end architecture includes the AI-defined interface between the perception sub-unit and the spatio-temporal sub-unit, the AI-defined interface between the spatio-temporal sub-unit and the first environment model sub-unit, and the AI-defined interface between the spatio-temporal sub-unit and the occupancy prediction sub-unit.

Clause 20. The method of any combination of Clauses 18-19, wherein the AI planning unit includes a deep learning (DL) prediction sub-unit and an AI planner sub-unit, and wherein the modular hybrid partial end-to-end architecture includes the AI-defined interface between the DL prediction sub-unit and the AI planner sub-unit.

Clause 21. The method of any combination of Clauses 14-18, wherein the modular hybrid architecture is a modular hybrid full end-to-end architecture, and wherein the one or more human-defined interfaces are between at least two task units of the plurality of task units, wherein the one or more AI-defined interfaces are between at least two task units the plurality of task units, and wherein the one or more AI-defined interfaces are between sub-units of at least one task unit of the plurality of task units.

Clause 22. The method of Clause 21, wherein the modular hybrid full end-to-end architecture includes the AI-defined interface between the perception unit and the second environment model unit, and includes the AI-defined interface between the perception unit and the AI planning unit.

Clause 23. The method of any combination of Clauses 21-22, wherein the modular hybrid full end-to-end architecture includes the AI-defined interface between the second environment model unit and the AI planning unit.

Clause 24. The method of any combination of Clauses 21-23, wherein the modular hybrid full end-to-end architecture includes the AI-defined interface between the second environment model unit and a map encoder.

Clause 25. The method of any of Clauses 14-24, wherein the automated driving system is part of an advanced driver assistance system (ADAS).

Clause 26. The method of any of Clauses 14-25, wherein the method is performed by a processing system in the vehicle.

Clause 27. An apparatus comprising means for performing any combination of methods of Clauses 14-26.

Clause 28. A non-transitory computer-readable storage medium storing instructions that, when executed, cause one or more processors to perform any combination of methods of Clauses 14-26.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of random-access memory (RAM), read-only memory (ROM), electrically erasable ROM (EEPROM), compact disc ROM (CD-ROM) or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus comprising:
one or more memories; and
one or more processors in communication with the one or more memories, the one or more processors configured to execute an automated driving system having a modular hybrid architecture, wherein the modular hybrid architecture includes a plurality of task units, and wherein the modular hybrid architecture includes one or more human-defined interfaces, and one or more AI-defined interfaces, and wherein the one or more processors are configured to:
receive input data from one or more sensors;
process the input data using the automated driving system having the modular hybrid architecture; and
control at least one operation of a vehicle according to an output of the automated driving system.

2. The apparatus of claim 1, wherein the plurality of task units includes one or more of a perception unit, a second environment model unit, an AI planning unit, a rule-planning unit, or a control unit.

3. The apparatus of claim 2, wherein the modular hybrid architecture is a modular hybrid partial end-to-end architecture, and wherein the one or more human-defined interfaces are between the plurality of task units, and wherein the one or more AI-defined interfaces are between sub-units of at least one task unit of the plurality of task units.

4. The apparatus of claim 3, wherein the perception unit includes a low level perception sub-unit, a spatio-temporal sub-unit, a first environment model sub-unit, and an occupancy prediction sub-unit, and wherein the modular hybrid partial end-to-end architecture includes the AI-defined interface between the perception sub-unit and the spatio-temporal sub-unit, the AI-defined interface between the spatio-temporal sub-unit and the first environment model sub-unit, and the AI-defined interface between the spatio-temporal sub-unit and the occupancy prediction sub-unit.

5. The apparatus of claim 4, wherein the AI planning unit includes a deep learning (DL) prediction sub-unit and an AI planner sub-unit, and wherein the modular hybrid partial end-to-end architecture includes the AI-defined interface between the DL prediction sub-unit and the AI planner sub-unit.

6. The apparatus of claim 2, wherein the modular hybrid architecture is a modular hybrid full end-to-end architecture, and wherein the one or more human-defined interfaces are between at least two task units of the plurality of task units, wherein the one or more AI-defined interfaces are between at least two task units of the plurality of task units, and wherein the one or more AI-defined interfaces are between sub-units of at least one task unit of the plurality of task units.

7. The apparatus of claim 6, wherein the modular hybrid full end-to-end architecture includes the AI-defined interface between the perception unit and the second environment model unit, and includes the AI-defined interface between the perception unit and the AI planning unit.

8. The apparatus of claim 6, wherein the modular hybrid full end-to-end architecture includes the AI-defined interface between the second environment model unit and the AI planning unit.

9. The apparatus of claim 6, wherein the modular hybrid full end-to-end architecture includes the AI-defined interface between the second environment model unit and a map encoder.

10. The apparatus of claim 1, wherein the automated driving system is part of an advanced driver assistance system (ADAS).

11. A method comprising:
executing an automated driving system having a modular hybrid architecture, wherein the modular hybrid architecture includes a plurality of task units, and wherein the modular hybrid architecture includes one or more human-defined interfaces, and one or more AI-defined interfaces, and wherein executing the automated driving system having the modular hybrid comprises:
receiving input data from one or more sensors;
processing the input data using the automated driving system having the modular hybrid architecture; and
controlling at least one operation of a vehicle according to an output of the automated driving system.

12. The method of claim 11, wherein the plurality of task units include one or more of a perception unit, a second environment model unit, an AI planning unit, a rule-planning unit, or a control unit.

13. The method of claim 12, wherein the modular hybrid architecture is a modular hybrid partial end-to-end architecture, and wherein the one or more human-defined interfaces are between the plurality of task units, and wherein the one or more AI-defined interfaces are between sub-units of at least one task unit of the plurality of task units.

14. The method of claim 13, wherein the perception unit includes a low level perception sub-unit, a spatio-temporal sub-unit, a first environment model sub-unit, and an occupancy prediction sub-unit, and wherein the modular hybrid partial end-to-end architecture includes the AI-defined interface between the perception sub-unit and the spatio-temporal sub-unit, the AI-defined interface between the spatio-temporal sub-unit and the first environment model sub-unit, and the AI-defined interface between the spatio-temporal sub-unit and the occupancy prediction sub-unit.

15. The method of claim 14, wherein the AI planning unit includes a deep learning (DL) prediction sub-unit and an AI planner sub-unit, and wherein the modular hybrid partial end-to-end architecture includes the AI-defined interface between the DL prediction sub-unit and the AI planner sub-unit.

16. The method of claim 12, wherein the modular hybrid architecture is a modular hybrid full end-to-end architecture, and wherein the one or more human-defined interfaces are between at least two task units of the plurality of task units, wherein the one or more AI-defined interfaces are between at least two task units of the plurality of task units, and wherein the one or more AI-defined interfaces are between sub-units of at least one task unit of the plurality of task units.

17. The method of claim 16, wherein the modular hybrid full end-to-end architecture includes the AI-defined interface between the perception unit and the second environment model unit, and includes the AI-defined interface between the perception unit and the AI planning unit.

18. The method of claim 16, wherein the modular hybrid full end-to-end architecture includes the AI-defined interface between the second environment model unit and the AI planning unit.

19. The method of claim 16, wherein the modular hybrid full end-to-end architecture includes the AI-defined interface between the second environment model unit and a map encoder.

20. A non-transitory computer-readable storage medium storing instructions that, when executed, cause one or more processors to:
execute an automated driving system having a modular hybrid architecture, wherein the modular hybrid architecture includes a plurality of task units, and wherein the modular hybrid architecture includes one or more human-defined interfaces, and one or more AI-defined interfaces;
receive input data from one or more sensors;
process the input data using the automated driving system having the modular hybrid architecture; and
control at least one operation of a vehicle according to an output of the automated driving system.
